(19) United States
(12) Patent Application Publication
(10) Pub. No.: US 2011/0282751 A1
(43) Pub. Date: Nov. 17, 2011

(54) METHOD AND SYSTEM FOR ADVERTISING USING MINIMUM INCREMENT BID

(75) Inventors: Ki Oh Kwon, Seongnam-si (KR); Yuwon Kim, Seongnam-si (KR); Won Sook Noh, Seongnam-si (KR); Woongsup Shin, Seongnam-si (KR); Woosung Lee, Seongnam-si (KR); Min Seon Jeon, Seongnam-si (KR); Seojin Han, Seongnam-si (KR)

(73) Assignee: NHN BUSINESS PLATFORM CORPORATION, Seongnam-si (KR)

(21) Appl. No.: 13/123,498

(22) PCT Filed: Oct. 9, 2009
(86) PCT No.: PCT/KR2009/005799

§ 371 Date: Jun. 30, 2011

(30) Foreign Application Priority Data
Oct. 9, 2008 (KR) 10-2008-0099100

(51) Int. Cl. G06Q 30/00

(52) U.S. Cl. 705/14.71

(57) ABSTRACT

A method and system for providing an advertisement using a minimum incremental unit are provided. The advertisement providing method includes adjusting a minimum incremental unit based on an initial bid price, an input bid price, and a maximum bid price bid price during an auction. The minimum incremental unit includes a minimum value of increment to be included in a current input bid price in addition to a previously input bid price.

### TECHNICAL FIELD

The present invention relates to a method and system for providing an advertisement using a minimum incremental unit, and more particularly, to a method and system for providing an advertisement adjusting a minimum incremental unit during an auction.

### BACKGROUND ART

Internet advertising, that is, advertising through the medium of the Internet, enables enterprises to contact a great number of consumers at a low cost and immediately recognize reactions of customers through an advertisement using merits of the Internet. Among the Internet advertising methods, keyword advertising refers to an advertising method that exposes an advertisement of a relevant enterprise on a screen as a search result upon input of a search term. For example, when a user inputs a search term related to ‘moving’, advertisements related to ‘pack moving’, ‘moving center’, and the like may be exposed as a result of the search. Thus, since advertisements are exposed to those interested in particular goods or services, the advertising effect will be high.

An Internet advertisement is sold to an advertiser in various forms of advertisement products. An advertisement to be exposed, corresponding to an advertisement product sold by an auction, may be determined by a bid price input by a corresponding advertiser. For example, an advertisement of an advertiser who suggested a second high bid price may be exposed as having a highest bid price, through an uppermost position of an advertisement exposure region among advertisement exposure regions related to the corresponding advertisement products. An advertisement providing method and system enabling efficient bidding will be described.

### DISCLOSURE OF INVENTION

### Technical Goals

An aspect of the present invention provides a method and system for providing an advertisement, capable of increasing a minimum incremental unit according to an increase in a bid price as an auction proceeds.

Another aspect of the present invention provides a method and system for providing an advertisement, capable of adjusting the minimum incremental unit according to an accelerated price increase determined in consideration of an initial bid price, an input bid price, and a maximum bid price.

### Technical Solutions

According to an aspect of the present invention, there is provided a method for providing an advertisement, the method including adjusting a minimum incremental unit based on an initial bid price, an input bid price, and a maximum bid price bid price during an auction, wherein the minimum incremental unit includes a minimum value of increment to be included in a current input bid price in addition to a previously input bid price.

The input bid price may include a bid price per unit time, which is input by an advertiser during the auction, and the bid price per unit time may include a bid price with respect to a cost necessary to expose the advertisement through one advertisement exposure region for at least one unit time.

The adjusting of the minimum incremental unit may include determining accelerated price increase based on the initial bid price, a mean of the input bid price, and the maximum bid price; and changing extent of the minimum incremental unit based on the accelerated price increase.

The minimum incremental unit may be increased according to an increase in a maximum value of a bid price being input as the auction proceeds.

According to another aspect of the present invention, there is provided a system for providing an advertisement, the system including a minimum incremental unit adjusting module to adjust a minimum incremental unit based on an initial bid price, an input bid price, and a maximum bid price during an auction. Here, the minimum incremental unit includes a minimum value of increment to be included in a current input bid price in addition to a previously input bid price.

### Effects

According to embodiments the present invention, since a minimum incremental unit is increased as a price increases with the progress of an auction, competition among advertisers may be achieved more efficiently and rapidly.

According to embodiments of the present invention, the minimum incremental unit is adjusted according to an accelerated price increase determined in consideration of an initial bid price, an input bid price, and a maximum bid price. Therefore, the minimum incremental unit becomes relatively great at the end of the auction. As a result, sniping, which is a phenomenon where biddings are concentrated only at the end of the auction, may be prevented.

In addition, according to embodiments of the present invention, an advertising cost is calculated per unit time based on a bid price per unit time according to a keyword and an advertisement exposure region, rather than being calculated according to a number of clicks of a link to an advertisement document. Therefore, problems caused by malicious clicks by a particular user or group may be fundamentally prevented.

### BRIEF DESCRIPTION OF DRAWINGS

FIG. 1 illustrates a diagram showing a part of a search result page corresponding to a keyword input by a user;

FIG. 2 illustrates a flowchart describing an advertisement providing method according to an embodiment of the present invention;

FIG. 3 illustrates a diagram showing a table containing example information on a bid price and a minimum incremental unit;

FIG. 4 illustrates a diagram describing a bid price per unit time; and

FIG. 5 illustrates a block diagram describing an inner structure of an advertisement providing system according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

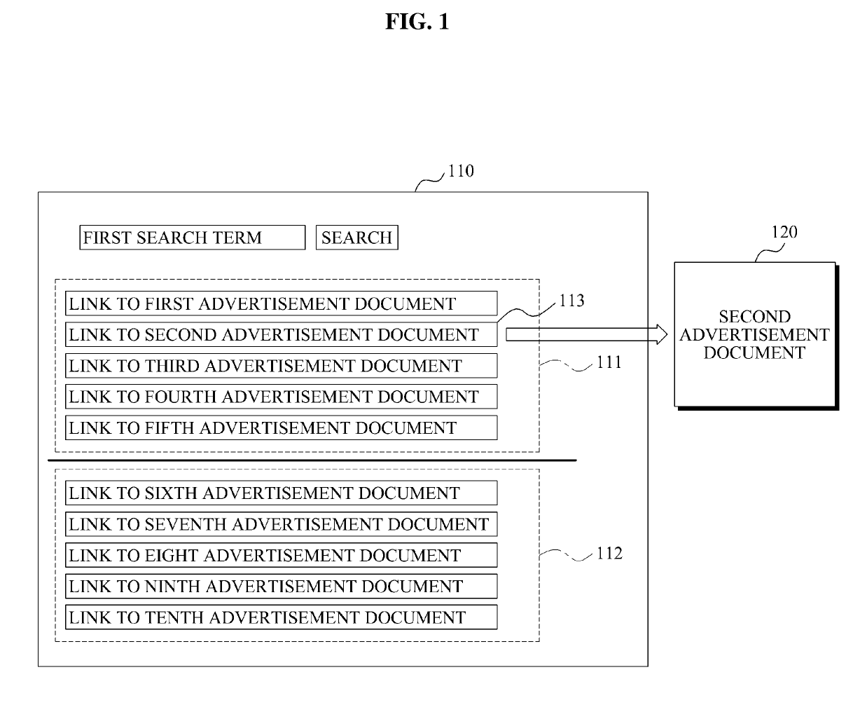

FIG. 1 illustrates a diagram showing a part of a search result page 110 corresponding to a keyword input by a user. The search result page 110 includes a search result regarding a first search term input by a user. The search result 110 may set links to advertisement documents per advertisement product as shown by two dotted-line boxes 111 and 112 in the drawing. Specifically, the search result page 110 according to the embodiment shows five links, each set for two advertisement products. Here, when a click event occurs with respect to a link 113 to a second advertisement document 120, the second advertisement document 120 may be provided to the user. Such links to the advertisement documents may be allocated to a sold region when a corresponding advertisement product is purchased according to the keyword such as the first search term. Sale of an advertisement exposure region set with the links may be performed through an auction.

An advertisement providing system according to the embodiment of the present invention may increase a minimum incremental unit as a price increases according to a progress of an auction, thereby inducing more efficient and rapid competition among advertisers. Also, sniping, which is a phenomenon where biddings are concentrated only at the end of the auction, may be prevented. In addition, a bid price input by an advertiser may include a bid price per unit time, which is input by the advertiser during the auction. The bid price per unit time may include an auction bid price with respect to a cost necessary to expose the advertisement through one advertisement exposure region for at least one unit time. In other words, the advertisement providing system may calculate the advertising cost according to the unit time based on the bid price per unit time according to the keyword and the advertisement exposure region, rather than calculating according to a number of clicks of the link to the advertisement document. Therefore, problems caused by malicious clicks by a particular user or group may be fundamentally prevented.

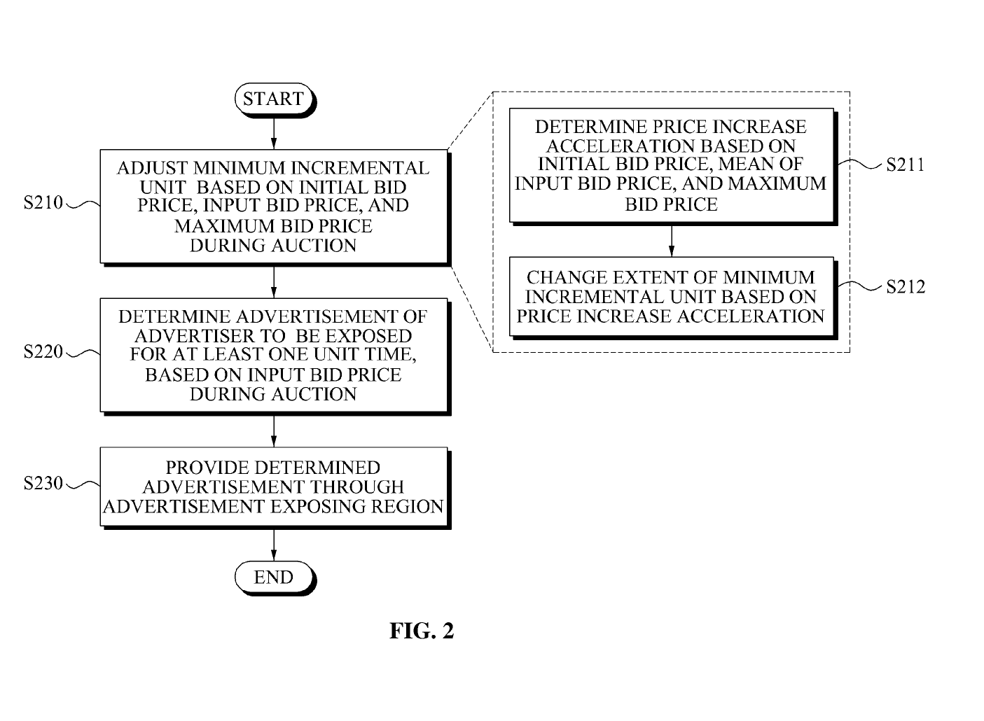

FIG. 2 illustrates a flowchart describing an advertisement providing method according to an embodiment of the present invention. The method illustrated by FIG. 2 may be performed by the advertisement providing system of FIG. 1. The advertisement providing method will be described with respect to respective operations of the advertisement providing system with reference to FIG. 2.

In operation S210, the advertisement providing system adjusts the minimum incremental unit based on an initial bid price, an input bid price, and a maximum bid price during the auction. The minimum incremental unit includes a minimum value of increment that is to be included in a current input bid price in addition to a previously input bid price. That is, the minimum incremental unit may be used to force the advertiser to input a higher bid price than a previous bid price by at least the minimum incremental unit. For example, when the minimum incremental unit is increased as the price increases with the progress of the auction, the minimum incremental unit becomes greater at the end of the auction in comparison to the beginning of the auction. Consequently, sniping may be prevented and competition among the advertisers may be achieved more efficiently and rapidly. Every time a bid price is input during the auction, the minimum incremental unit may be adjusted.

For this, the advertisement providing system may adjust the minimum incremental unit based on the initial bid price, a bid price previously input during the auction, and the maximum bid price. Here, the minimum incremental unit may be adjusted to be increased according to an increase in the maximum bid price being input with the progress of the auction. In addition, as shown in FIG. 2, the advertisement providing system may perform operation S211 of determining an accelerated price increase based on the initial bid price, a mean of the input bid prices, and the maximum bid price, and operation S212 of changing extent of the minimum incremental unit based on the accelerated price increase, during the operation S210. That is, the advertisement providing system may increase the minimum incremental unit as the price increase is accelerated. Here, the accelerated price increase may be determined using an exponential function or a logarithmic function.

According to the embodiment of the present invention, the minimum incremental unit may be set as desired by an operator of the advertisement providing system. The minimum incremental unit may be used as a factor for adjusting an actual cost of the advertiser to be slightly higher than a bid price of a next-priority advertiser. The minimum incremental unit may be determined based on a monetary unit of the bid price of the advertiser. For example, presuming that the minimum incremental unit is set to 1/100 of a monetary unit of the bid price of the advertiser, when the bid price of the advertiser is in units of 100 thousand won, the minimum incremental unit becomes one thousand won. When the bid price of the advertiser is in units of 10 thousand won, the minimum incremental unit becomes 100 won. This will be more easily understood by referring to Table 1 below.

TABLE 1

| Exposure priority | Bid price | Actual cost |
|---|---|---|
| First | 101,000 won | 101,000 won + 1,000 won |
| Second | 10,100 won | 9,010 won + 100 won |
| Third | 9,010 won | Bid price of next-priority |
| | | advertiser + minimum incremental |
| | | unit |

Hereinafter, an example method for bidding a keyword of the advertiser will be described in detail. In the following description, specific dates, days, and hours are suggested only by way of example. Therefore, various other dates, days, and hours or their altered forms may be used.

\textcircled{1}Regular bidding

For example, the regular bidding may be closed at 3 p.m. every Wednesday and an advertisement may be exposed for 7 days from midnight the next day, that is, on Thursday. The advertiser may be notified of a result of successful bidding by e-mail or a mobile phone message. Since, regular bidding starts anew right after the previous regular bidding of Wednesday at 3 p.m., the advertiser may participate in the next regular bidding even though the advertiser failed to make a successful bid.

\textcircled{2}Irregular bidding

The irregular bidding, that is, additional bidding may be performed everyday for remaining publication days (7-DAY) with respect to keywords passed or cancelled for bidding. When any keyword needs to be exposed even for a short time, the advertiser may expose the corresponding advertisement through the irregular bidding even after the regular bidding is closed. Information on a number or type of the passed or cancelled keywords may be supplied through a dedicated management page, thereby enabling the advertiser to participate in the irregular bidding.

\textcircled{3}Automatic bidding

The automatic bidding enables the advertiser to more conveniently manage the advertising, that is, the advertiser who wants keyword advertising at a minimum management cost. The advertiser who uses the automatic bidding may manage advertising according to advertisement groups. In addition, the advertiser may automatically participate in the regular bidding without having to check a bidding state every time, through a bidding on/off function and an additional bidding participation option. When using the additional bidding participation option, the advertiser may be able to automatically participate in the irregular bidding occurring due to various reasons.

The initial bid price may be determined according to a bid object keyword to be bid by the advertiser. For example, the initial bid price with respect to a unit time (duration for exposure of an advertisement) of the bid object keyword may be determined using data related to a number of searches for the bid object keyword and the number of clicks of the advertisement using the bid object keyword. In this case, an advertising cost and an advertisement exposure priority with respect to one advertisement document during the unit time may be fixed. Also, the initial bid price with respect to a unit time of the bid object keyword may be determined based on advertisement history information of the bid object keyword. The advertisement history information may include at least one of all types of measurable information related to the bid object keyword, such as a number of clicks, a cost per click (CPC), a number of hits, a number of exposures, and a number of purchases. For example, an average CPC of the bid object keyword and an average number of clicks corresponding to the unit time for exposure of the advertisement may be used as the advertisement history information. When bidding of a keyword for exposing an advertisement for ‘7 days’ is performed, the initial bid price for the bid object keyword may be determined as “average CPC X estimated averaged number of clicks for 7 days.”

In operation S220, the advertisement providing system may determine an advertisement of the advertiser, to be exposed for at least one unit time based on the bid price being input during the auction. Here, the ‘unit time’ refers to a time duration from a certain time to another certain time. The certain time with respect to a random keyword and the advertisement exposure region (or a field on a webpage) according to the random keyword may be determined as necessary by the operator of the advertisement providing system or the advertiser. For example, the advertisement providing system may divide one day into 144 unit times each of a 10-minute interval, with respect to the keyword and the advertisement exposure region. The bid price per unit may include an auction bid price with respect to a cost necessary to expose the advertisement through one advertisement exposure region for at least one unit time. In other words, the advertising cost is calculated according to the unit time based on the bid price per unit time according to the keyword and the advertisement exposure region, rather than according to a number of clicks of the link to the advertisement document. Therefore, problems caused by malicious clicks by a particular user or group may be fundamentally prevented.

In operation S230, the advertisement providing system may provide the determined advertisement through a corresponding advertisement exposure region. Specifically, the advertisement providing system sets a link to an advertisement document corresponding to the advertisement, in the advertisement exposure region of the webpage, and provides the advertisement document to the user who generates an event to the link, thus providing the advertisement through the advertisement exposure region. In this case, the advertising cost and the advertisement exposure priority with respect to one advertisement document may be fixed during one unit time.

That is, in bidding of the advertisement document, the initial bid price with respect to the bid object keyword may be determined so that the advertisers perform keyword bidding, and the advertisement may be provided to the advertisers ranked in a descending order of bid prices. For example, the advertisements may be provided to the advertisers of a first priority to a fifth priority through five advertisement exposure regions. While the priority of the advertisers is determined in the descending order of the bid price, the actual cost paid by an advertiser may be determined based on a bid price of a next-priority advertiser. In this case, the actual cost paid by the advertiser may be set equal to the bid price of the next-priority advertiser. However, the actual cost may be determined as an amount calculated by adding the bid price of the next-priority advertiser to the minimum incremental unit. That is, it may be satisfied as follows “actual cost=bid price of next-priority advertiser+minimum incremental unit.”

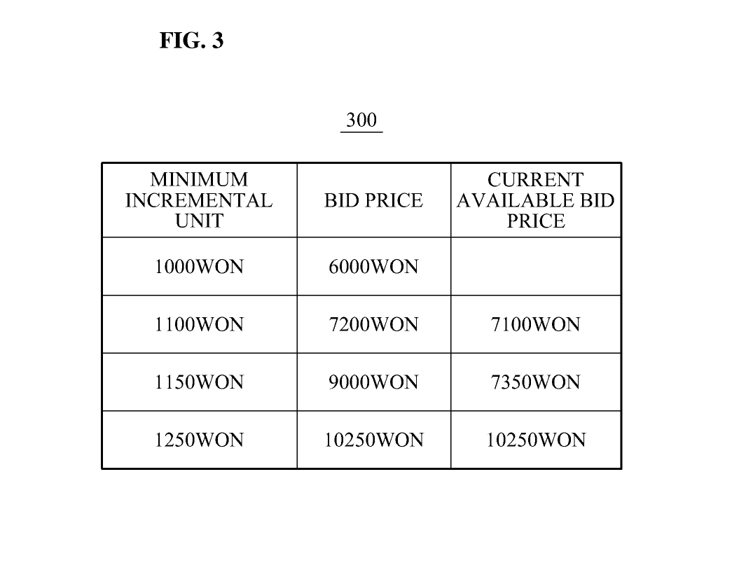

FIG. 3 illustrates a table 300 containing example information on the bid price and the minimum incremental unit. The table 300 shows a current available bid price calculated based on the minimum incremental unit and the previously input bid price. For example, when the minimum incremental unit is “1,100 won” and the previously input bid price is “6,000 won” in the example case of FIG. 3, the current input bid price may be forced to be at least “7,100 won.” In other words, the advertisement providing system may allow input of only a bid price of at least “7,100 won” suggested by an advertiser. Here, as shown in FIG. 3, the minimum incremental unit is adjusted to be increased as the price increases with the progress of the auction. Therefore, sniping, that is a phenomenon where biddings are concentrated only at the end of the auction, may be prevented.

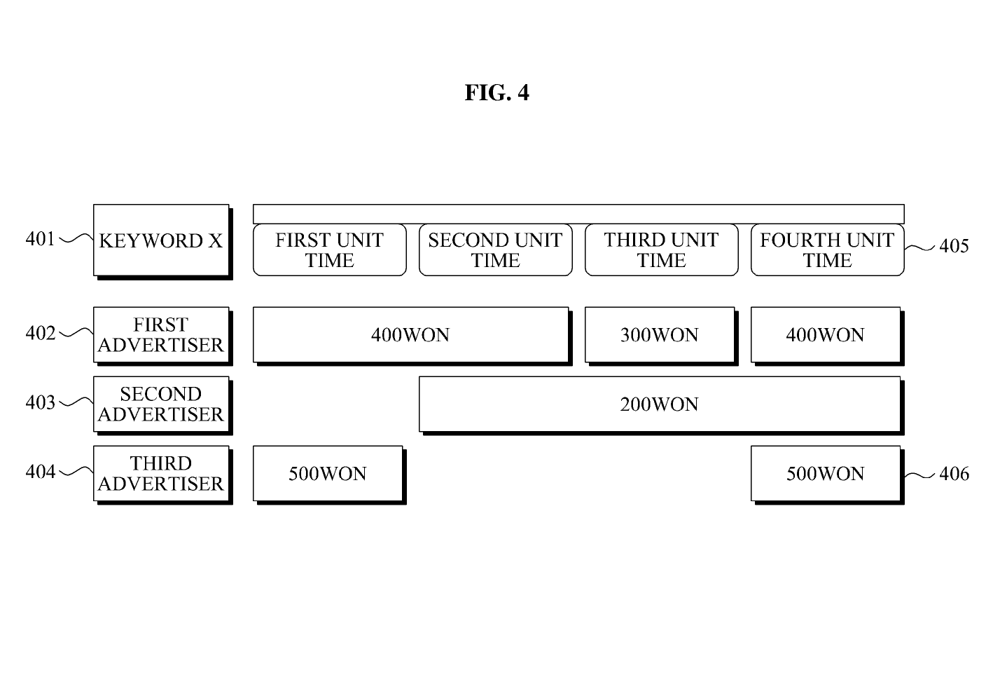

FIG. 4 illustrates a diagram describing the bid price per unit time. Here, the bid price per unit refers to a bid price with respect to a unit time, not with respect to clicks. FIG. 4 shows bid prices per unit time input by a first advertiser 402, a second advertiser 403, and a third advertiser 404 with respect to a keyword X 401. As shown in FIG. 4, the first advertiser 402 suggested 400 won for a first unit time and a second unit time, 300 won for a third unit time, and 400 won for a fourth unit time 405. Presuming that sale is performed simply by the bid price per unit time with respect to the corresponding unit time, an advertisement of the third advertiser 404, who suggested ‘500 won’ as a highest bid price 406 per unit time, with respect to the fourth unit time 405, may be exposed in the corresponding advertisement exposure region with respect to the keyword X 401 during the fourth unit time 405. As aforementioned, according to the embodiments of the present invention, the advertising cost is calculated per unit time based on the bid price per unit time corresponding to the keyword and the advertisement exposure region, rather than being calculated according to the number of clicks of the link to the advertisement document. Therefore, problems caused by malicious clicks by a particular user or group may be fundamentally prevented.

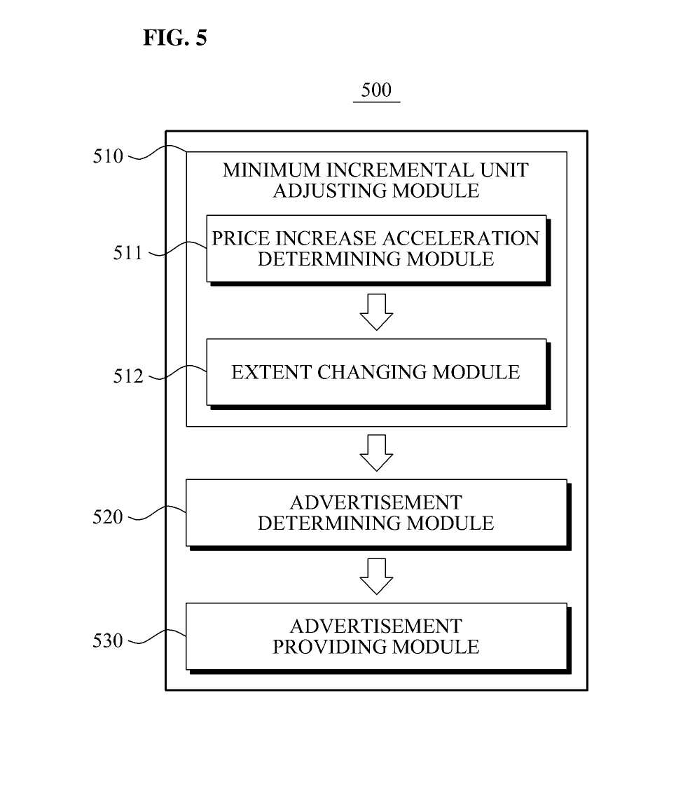

FIG. 5 illustrates a block diagram describing an inner structure of an advertisement providing system 500 according to an embodiment of the present invention. Referring to FIG. 5, the advertisement providing system 500 may include a minimum incremental unit adjusting module 510, an advertisement determining module 620, and an advertisement providing module 530.

The minimum incremental unit adjusting module 510 adjusts a minimum incremental unit based on an initial bid price, an input bid price, and a maximum bid price. The minimum incremental unit includes a minimum value of increment that is to be included in a current input bid price in addition to a previously input bid price. That is, the minimum incremental unit may be used to force the advertiser to input a higher bid price than a previous bid price by at least the minimum incremental unit. For example, the minimum incremental unit is increased as the price increases with the progress of the auction. Consequently, sniping may be prevented and competition among the advertisers may be achieved more efficiently and rapidly. Every time the bid price is input during the auction, the minimum incremental unit may be adjusted.

For this, the minimum incremental unit adjusting module 510 may adjust the minimum incremental unit based on the initial bid price, the bid price previously input during the auction, and the maximum bid price. Here, the minimum incremental unit may be adjusted to be increased according to an increase in the maximum bid price being input with the progress of the auction. In addition, as shown in FIG. 5, the minimum incremental unit adjusting module 510 may include an accelerated price increase determining module 511 determining an accelerated price increase based on the initial bid price, a mean of the input bid price, and the maximum bid price, and an extent change module 512 changing extent of the minimum incremental unit based on the accelerated price increase. That is, the minimum incremental unit adjusting module 510 may increase the minimum incremental unit as the price increase is accelerated. Here, the accelerated price increase may be determined using an exponential function or a logarithmic function.

The advertisement determining module 520 may determine an advertisement of an advertiser, to be exposed for at least one unit time, based on the bid price being input during the auction. Here, the input bid price may include an auction bid price per unit time, which is input by the advertiser during the auction. The bid price per unit time may include an auction bid price with respect to a cost necessary to expose the advertisement through one advertisement exposure region for at least one unit time. In this case, the advertising cost may be calculated according to the unit time based on the bid price per unit time according to the keyword and the advertisement exposure region, rather than according to a number of clicks of the link to the advertisement document. Therefore, problems caused by malicious clicks by a particular user or group may be fundamentally prevented.

The advertisement providing module 530 may provide the determined advertisement through the corresponding advertisement exposure region. Specifically, the advertisement providing module 530 may set the link to an advertisement document corresponding to the advertisement in the advertisement exposure region of the webpage, and provide the advertisement document to the user who generates an event to the link, thereby providing the advertisement through the advertisement exposure region.

According to the advertisement providing method and system as described in the forgoing, the minimum incremental unit is increased as the price increases with the progress of the auction, thereby inducing more efficient and rapid competition among advertisers. Also, since the minimum incremental unit is adjusted according to the accelerated price increase determined in consideration of the initial bid price, the input bid price, and the maximum bid price. Therefore, the minimum incremental unit becomes relatively great at the end of the auction. As a result, sniping, which is a phenomenon where biddings are concentrated only at the end of the auction, may be prevented.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method for providing an advertisement, the method comprising:
adjusting a minimum incremental unit based on an initial bid price, an input bid price, and a maximum bid price during an auction,
wherein the minimum incremental unit comprises a minimum value of increment to be included in a current input bid price in addition to a previously input bid price.

2. The method of claim 1, wherein
the input bid price comprises a bid price per unit time, which is input by an advertiser during the auction, and
the bid price per unit time comprises a bid price with respect to a cost necessary to expose the advertisement through one advertisement exposure region for at least one unit time.

3. The method of claim 1, wherein the adjusting a minimum incremental unit comprises:
determining an accelerated price increase based on the initial bid price, a mean of the input bid prices, and the maximum bid price; and
changing an extent of the minimum incremental unit based on the accelerated price increase.

4. The method of claim 1, wherein the minimum incremental unit is increased according to an increase in a maximum value of a bid price being input with progress of the auction.

5. The method of claim 1, further comprising:
determining an advertisement of an advertiser to be exposed for at least one unit time based on a bid price during the auction; and
providing the determined advertisement through a corresponding advertisement exposure region.

6. The method of claim 1, wherein the minimum incremental unit is adjusted by time of each bid price being input during the auction.

7. A non-transitory computer readable storage medium comprising an executable program, which when executed, performs the method of claim 1.

8. A system using a server for providing an advertisement, the system comprising:
a processor of the server configured to adjust a minimum incremental unit based on an initial bid price, an input bid price, and a maximum bid price during an auction,
wherein the minimum incremental unit comprises a minimum value of increment to be included in a current input bid price in addition to a previously input bid price.

9. The system of claim 8, wherein
the input bid price comprises a bid price per unit time during the auction, and
the bid price per unit time comprises a bid price with respect to a cost necessary to expose the advertisement through at least one advertisement exposure region for at least one unit time.

10. The system of claim 8, further comprising:
a minimum incremental unit configured to adjust modules comprising
an accelerated price increase determining module to determine an accelerated price increase based on the initial bid price, a mean of the input bid price, and the maximum bid price; and
an extent changing module to change extent of the minimum incremental unit based on the accelerated price increase.

11. The system of claim 10, wherein the minimum incremental unit is increased according to an increase in a maximum value of a bid price being input associated with progress of the auction.

12. The system of claim 8, further comprising:
an advertisement determining module configured to determine an advertisement of an advertiser to be exposed for at least one unit time based on a bid price input during the auction; and
an advertisement providing module configured to provide the determined advertisement through a corresponding advertisement exposure region.

13. The system of claim 8, wherein the minimum incremental unit is adjusted by time of each bid price being input during the auction.
